(19) United States
(12) Patent Application Publication
(10) Pub. No.: US 2003/0120669 A1
(43) Pub. Date: Jun. 26, 2003

(54) Duplex structure of main-memory DBMS using log information in diskless environment and method for controlling consistency of data of main-memory DBMS

(76) Inventors: Mi Kyoung Han, Daejeon (KR); Wan Choi, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/310,465

(22) Filed: Dec. 4, 2002

(30) Foreign Application Priority Data
Dec. 26, 2001 (KR) 2001-84603

(51) Int. Cl. G06F 17/30

(52) U.S. Cl. 707/100

(57) ABSTRACT

A duplex structure of a main-memory DBMS (DataBase Management System) using log information and a method for controlling consistency of data of the main-memory DBMS. A duplex structure of a main-memory DBMS having a standby-side DBMS and an active-side DBMS through a network in a system environment without a secondary storage device such as a disk, comprising: the two DBMSs, each including: a state manager for setting up and managing a standby or active state of the DBMS; a DBMS server having a log pool containing at least one log page for creating update information and update database on a transaction-by-transaction basis using a log record structure and committing and recovering a transaction; and a duplex manager for transmitting at least one log record being change information of a memory database contained in the active-side DBMS to the standby-side DBMS and reflecting the received log record in a memory database contained in the standby-side DBMS, to control consistency of data of duplex memory databases, wherein the DBMS server obtains a log page allocated from the log pool, connects the allocated log page to a transaction table, stores the log record in the log page, and updates data of a corresponding database portion.

### BACKGROUND OF THE INVENTION

1. Field of the Invention

The present invention relates to a duplex structure of a main-memory DBMS (DataBase Management System) using log information and a method for controlling consistency of data of the main-memory DBMS, wherein the duplex structure of the main-memory DBMS and the method can efficiently support a duplex function so that a continuous data service can be provided while the main-memory DBMS managing data is operated in an environment without a secondary storage device such as a disk.

2. Description of the Related Art

Initial DBMSs (DataBase Management Systems) mainly employed a data duplication method for duplicating data in each processor and managing the duplicated data for high availability. For database duplication, when data of one site is changed, data of the other site is identically changed, thereby accomplishing consistency of data. For data synchronization, a consistency control method, etc. based on a two-phase commit protocol or an asynchronous transfer mode are employed, and a method capable of permitting only a central database server to update data by separating a right to update data and an access right is also employed. However, because all processors associated with the duplicated data should process the duplicated data in the consistency control method based on the two-phase commit protocol, a probability of a transaction failure is high, and the consistency of data cannot be completely ensured in the asynchronous transfer mode. A method for changing data using the central database server to improve the consistency of data cannot continuously provide a consistent data service where the central database server system has failed, and significant time is needed for controlling the consistency of data if the number of duplicated data-related processors is increased. Moreover, there is a problem of risk of an SPOF (Single Point Of Failure) associated with the possibility of a failure in a high availability system due to a complicated structure.

To address the above-described problems, a method using hardware or clustering software having high-availability characteristics is conventionally applied to a system. Here, the system is an expensive system. Further, since clustering technologies are focused to manage a state of a process, it is difficult for the clustering technologies to be applied to manage a main-memory database.

A polyhedra system as a memory resident DBMS has a complicated structure having a separate arbitrator database in addition to an active-side DBMS and a standby-side DBMS for database duplex. To change data, the polyhedra system employs snapshot technologies for copying a corresponding database schema and data contents in a disk file before a database is changed. To recover the system, the polyhedra system creates journal control data and records the created data in the disk file. At the time of transaction recovery, original data is copied in the database and then the database is recovered to a state before a transaction. The created journal control data is transferred to a standby processor and used for controlling the consistency of data between two systems. Because the polyhedra system should store a snapshot to change data, it necessarily needs a secondary storage device and a standby side also uses the snapshot technologies to apply the journal control data to the system. Accordingly, where many transactions are simultaneously performed, there are problems in that a significant time and space is needed to copy a database at a transaction start point and hence a method for managing the many transactions is complicated.

### SUMMARY OF THE INVENTION

Therefore, the present invention has been made in view of the above problems, and it is an object of the present invention to provide a duplex structure of a main-memory DBMS (DataBase Management System) using log information in a diskless environment and a method for controlling consistency of data of the main-memory DBMS, wherein the duplex structure of the main-memory DBMS and the method can ensure performance of the main-memory DBMS and implement high-availability characteristics at low cost by providing a transaction recovery function and a duplex function with storing and managing log information on a transaction-by-transaction basis using a simplified log record structure.

In accordance with one aspect of the present invention, the above and other objects can be accomplished by the provision of a duplex structure of a main-memory DBMS having a standby-side DBMS (DataBase Management System) and an active-side DBMS through a network in a system environment without a secondary storage device such as a disk, comprising: the two DBMSs, each including: a state manager for setting up and managing a standby or active state of the DBMS; a DBMS server having a log pool containing at least one log page for creating update information and updates database on a transaction-by-transaction basis using a log record structure and committing and recovering a transaction; and a duplex manager for transmitting at least one log record being update information of a memory database contained in the active-side DBMS to the standby-side DBMS and reflecting the received log record in a memory database contained in the standby-side DBMS, to control consistency of data of duplex memory databases, wherein the DBMS server obtains a log page allocated from the log pool, connects the allocated log page to a transaction table, stores the log record in the log page, and changes data of a corresponding database portion.

In accordance with another aspect of the present invention, there is provided a method for controlling consistency of data of a memory databases in a duplex structure of a main-memory DBMS (DataBase Management System) having a standby-side DBMS and an active-side DBMS through a network in a system environment without a secondary storage device such as a disk, comprising the steps of: a) creating at least one log record on a transaction-by-transaction basis if a query processor of the active-side DBMS receives a update command from a user, obtaining at least one log page allocated from a log pool, connecting the log page to a transaction table, storing the log record in the log page, and changing data of a corresponding database portion; b) transmitting the log record to the standby-side DBMS if the transaction is committed, returning the allocated log page to the log pool, and terminating the transaction; c) obtaining at least one log page allocated from a log pool if the standby-side DBMS receives the log record from the active-side DBMS, connecting the log page to a transaction table, and storing the received log record in the log page; and d) transmitting a result of the reception to the active-side DBMS after storing the log record, and updating a memory database using the stored log record.

In accordance with yet another aspect of the present invention, there is provided a computer-readable recording medium in a duplex computer, the recording medium recording a program to perform the functions of: a) creating at least one log record on a transaction-by-transaction basis if a query processor of the active side receives a update command from a user, obtaining at least one log page allocated from a log pool, connecting the log page to a transaction table, storing the log record in the log page, and updating data of a corresponding database portion; b) transmitting the log record to the standby side if the transaction is committed, returning the allocated log page to the log pool, and terminating the transaction; c) obtaining at least one log page allocated from a log pool if the standby side receives the log record from the active side, connecting the log page to a transaction table, and storing the received log record in the log page; and d) transmitting a result of the reception to the active side after the log record is stored in the standby side, and updating a memory database using the stored log record.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a duplex structure of a memory-resident DBMS (DataBase Management System) in accordance with the present invention;

FIG. 2 is a view illustrating a log record structure for duplex in accordance with the present invention;

FIG. 3 is a view explaining a structure for managing log records on a transaction-by-transaction basis in a diskless environment in accordance with the present invention;

FIG. 4 is a flow chart illustrating a method for managing the log records on the transaction-by-transaction basis in accordance with the present invention; and

FIG. 5 is a flow chart illustrating a method for controlling consistency of database data in accordance with the present invention.

### DESCRIPTION OF THE PREFERRED EMBODIMENTS

The present invention connects two systems in which DBMSs (DataBase Management Systems) are resident to a network, classifies the two systems into an active-side DBMS and a standby-side DBMS, and enables only the active-side DBMS to be interworked and operated with an external application program. To recover a transaction, database update-related records are stored and managed on a transaction-by-transaction basis using a simplified log record structure, before update a database. A DBMS server generates and manages a log pool so that logs can be managed on the transaction-by-transaction basis. When a memory database of the active-side DBMS is updated, pieces of the log information created to provide high-availability characteristics are simultaneously transmitted to the standby-side DBMS at a transaction commit time and then consistency of data between memory databases of the active-side DBMS and the standby-side DBMS is controlled. The present invention manages log records on the transaction-by-transaction basis to simplify a log record structure. The present invention can record the log records on the transaction-by-transaction basis while managing the log pool within the DBMS. Moreover, the present invention enables only completed transaction information to be transmitted to the standby-side DBMS, thereby excluding an application of a mutual exclusion algorithm in a procedure of recording log records in a shared log buffer of a conventional DBMS and hence providing a high performance and high availability DBMS.

Now, preferred embodiments of the present invention will be described in detail with reference to the annexed drawings.

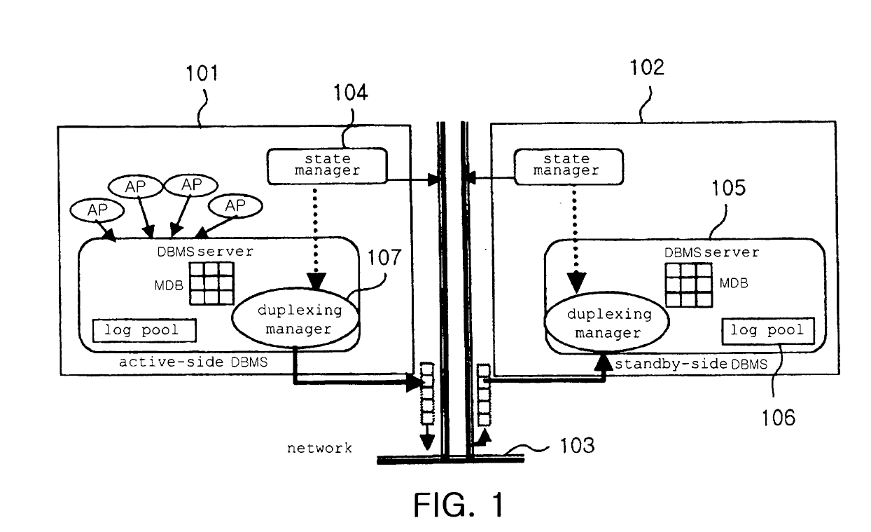

FIG. 1 is a view illustrating a duplex environment of memory-resident DBMS with no secondary storage device in accordance with the present invention.

In accordance with the present invention, DBMSs loaded and operated in two systems of a duplex DBMS structure act as an active-side DBMS 101 and a standby-side DBMS 102, and the two systems transmit and receive information through a network 103.

A state manager 104 of each system performs operations associated with a state of the system such as an operation of checking a state of the DBMS, an operation of setting up a state of the system, and an operation of transmitting a request for a state switching between the two systems. State managers 104 employ heartbeat signal to identify states of the two systems. A DBMS server 105 creates update information and updates a memory database on a transaction-by-transaction basis using a log record structure, and commits and recovers a transaction. At this time, a log pool 106, including log pages within the DBMS server 105, is managed so that log information on a transaction-by-transaction basis can be managed.

Duplex managers 107 perform a function of controlling consistency of two duplex MDBS. A duplex manager 107 enables log records being change information of the MDB contained in the active-side DBMS 101 to be transmitted to the standby-side DBMS 102 and enables received log records to be reflected to an MDB contained in the standby-side DBMS 102. Accordingly, when states of the two systems are switched, a job for switching operation of state within the DBMS is immediately performed so that a data service can be continuously provided on standby-side DBMS.

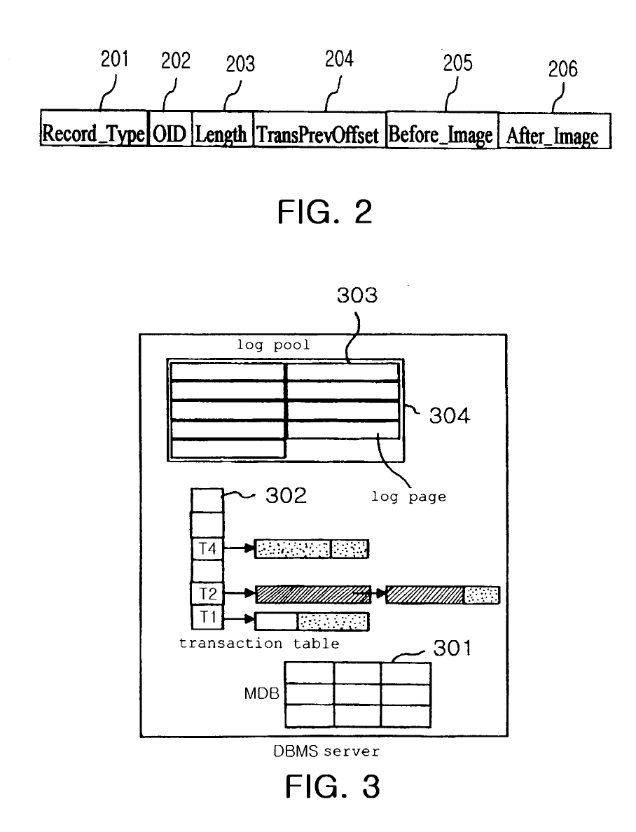

FIG. 2 shows a structure of log records for transaction recovery and duplex in accordance with the present invention.

Because the log records are generated and managed on a transaction-by-transaction basis, each log record includes only minimum information necessary for the transaction recovery and duplex. In the log record, a field of “Record_Type” 201 stores information indicating whether a type of a log record is a physical or logical log record. A field of an OID (Object Identifier) 202 stores information indicating a location of update data within the database. A field of “Length” 203 stores information indicating a size of the update data. A field of “TransPrevOffset” 204 stores information indicating a location of a previous log record to be used to recover a subsequent transaction when a transaction is recovered using log records recorded in a log pool on the transaction-by-transaction basis. A field of “Before_Image” 205 stores an old-value data as information used for recovering the transaction. A field of “After_Image” 206 stores a new-value data as information used for duplex.

FIG. 3 is a view illustrating a structure for managing log records on a transaction-by-transaction basis using a log pool in a duplex environment of memory-resident DBMS without a secondary storage device.

Update information for an MDB (Memory DataBase) 301 are recorded using a structure of log records on the transaction-by-transaction basis. At this time, a transaction table 302 stores a log page 304 allocated from a log pool 303 of a memory managed by a DBMS in a corresponding portion so that the created log records are stored and managed on the transaction-by-transaction basis. After corresponding log records are transmitted to a standby side if a transaction is committed, the log page is returned to a log pool and the returned log page is reused, a recovery procedure is performed using the log records at a transaction recovery time, and the log records are returned to the log pool.

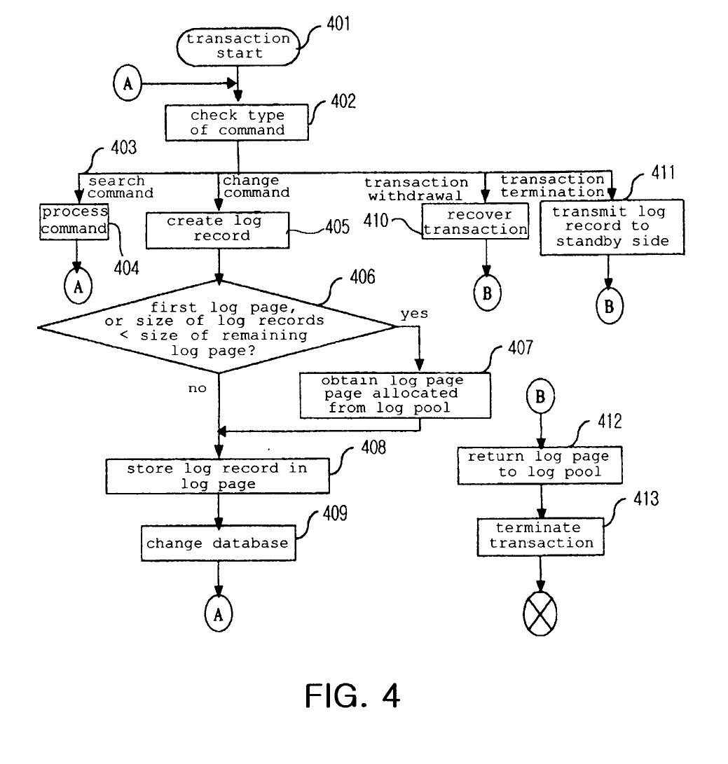

FIG. 4 is a flow chart illustrating a method for managing a log record on a transaction-by-transaction basis in accordance with the present invention.

If a transaction begins at step 401, a type of a command for accessing a database is checked at step 402. If the type of the command is a search command representing a reference numeral “403”, a corresponding command process is performed at step 404. If the type of the command indicates an update command, a log record for a corresponding data update is created at step 405. A procedure of creating the log record will be described as follows. At first, the log record is allocated from a log pool. If an allocated log page does not exist or a log-record storage space included in the allocated log page is insufficient at step 406, a new log page is allocated from the log page at step 407. After connecting the log page to a log table, log records are stored in the log page at step 408 and data of a corresponding database portion is changed at step 409. If a transaction rollback command is required after performing a procedure of processing a command for accessing the database, a transaction recovery procedure is performed using the log records within the log page connected to a corresponding transaction table at step 410. If a transaction commit command is issued, log records within a corresponding log page are transmitted to the standby side at step 411. Allocated log pages are then returned to the log pool for reuse at step 412, and a transaction termination process is performed at step 413.

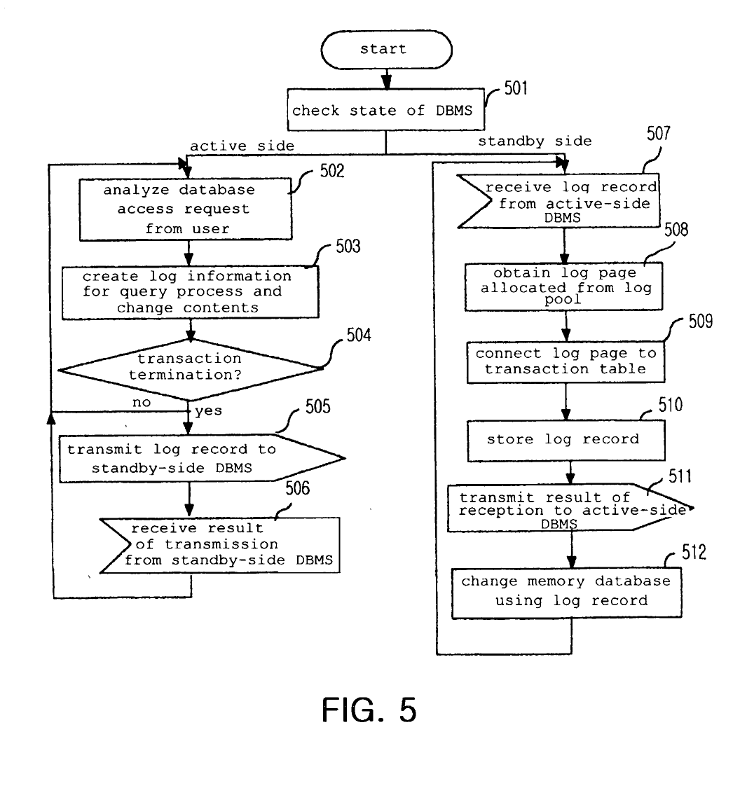

FIG. 5 is a flow chart illustrating a method for controlling consistency of database data in accordance with the present invention.

A state of a DBMS is checked at step 501. If the state of the DBMS is an active state, a query processor analyzes a database access request from a user at step 502. If an update command is issued, update information is created in at least one log record and a query processing procedure is performed at step 503. The above step 503 will be described in detail with reference to FIG. 4. If a transaction termination request is issued at step 504, the log records are transmitted to a standby-side DBMS through the duplex manager at step 505 so that a continuous service can be provided through control of database consistency. A result of the transmission is received from the standby-side DBMS at step 506. If the standby-side DBMS receives log records from the active-side DBMS through the duplex manager at step 507, a log page is allocated from a log pool at step 508 so that the received log records can be stored. The allocated log page is connected to the transaction table at step 509 and the log records received from the active-side DBMS are stored at step 510. A result of the reception is transmitted to the active-side DBMS at step 511. To control the database consistency using the log records stored in the standby-side DBMS, a memory database update process is performed at step 512, thereby enabling the database to be accessed at any time.

As apparent from the above description, the present invention can provide information associated with states of a database and a DBMS, which cannot be provided in the conventional clustering technologies, by performing a duplex process to provide high availability of the system while using a duplex environment of memory-resident DBMS without a secondary storage device such as a disk. The present invention can continuously process a user request where a failure of an active system occurs, and can reduce an amount of transmitted data and exclude unnecessary transaction recovery by transmitting only log information for a committed transaction to a standby side. The present invention can omit a lock and release function for a mutual exclusion at the time of applying an algorithm for generally sharing a log buffer and hence implement a high performance system by operating a log pool within a DBMS to record log records, obtaining an allocated log page and recording the log records in the log page on a transaction-by-transaction basis. Further, the present invention can minimize an amount of log information by including only minimum information necessary for transaction recovery and control of consistency of a standby-side database because the log records are generated and managed on a transaction-by-transaction basis. Moreover, the present invention can minimize a change of a structure of an existing DBMS and implement high-availability characteristics at low cost.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A duplex structure of a main-memory DBMS having a standby-side DBMS (DataBase Management System) and an active-side DBMS through a network in a system environment without a secondary storage device such as a disk, comprising:
the two DBMSs, each including:
a state manager for setting up and managing a standby or active state of the DBMS;
a DBMS server having a log pool containing at least one log page for creating update information and update database on a transaction-by-transaction basis by using a log record structure and completing and recovering a transaction; and
a duplex manager for transmitting at least one log record being update information of a memory database contained in the active-side DBMS to the standby-side DBMS and reflecting the received log record in a memory database contained in the standby-side DBMS, to control consistency of data of duplex memory databases,
wherein the DBMS server obtains a log page allocated from the log pool, connects the allocated log page to a transaction table, stores the log record in the log page, and update corresponding database portion.

2. The duplex structure of the main-memory DBMS as set forth in claim 1, wherein the log record includes:
a record-type field for storing information indicating whether a type of the log record is a physical or logical log record;
an object-identifier field for storing information indicating a location of update data within the database;
a length field for storing information indicating a size of update data;
a field for storing information indicating a location of the previous log record to be used to recover a subsequent transaction when a transaction is recovered using log records recorded in a log pool on the transaction-by-transaction basis;
a field for storing a old-value data as information used for recovering the transaction; and
a field for storing a new-value data as information used for duplex.

3. The duplex structure of the main-memory DBMS as set forth in claim 1, wherein the DBMS server obtains a new log page allocated from the log page and stores the log record in the log page, if the allocated log page does not exist or a log-record storage space included in the allocated log page is insufficient.

4. A method for controlling consistency of data of a memory databases in a duplex structure of a main-memory DBMS (DataBase Management System) having a standby-side DBMS and an active-side DBMS through a network in a system environment without a secondary storage device such as a disk, comprising the steps of:
a) creating at least one log record on a transaction-by-transaction basis if a query processor of the active-side DBMS receives a update command from a user, obtaining at least one log page allocated from a log pool, connecting the log page to a transaction table, storing the log record in the log page, and changing data of a corresponding database portion;
b) transmitting the log record to the standby-side DBMS if the transaction is committed, returning the allocated log page to the log pool, and terminating the transaction;
c) obtaining at least one log page allocated from a log pool if the standby-side DBMS receives the log record from the active-side DBMS, connecting the log page to a transaction table, and storing the received log record in the log page; and
d) transmitting a result of the reception to the active-side DBMS after storing the log record, and changing a memory database using the stored log record.

5. The method as set forth in claim 4, wherein the log record includes:
a record-type field for storing information indicating whether a type of the log record is a physical or logical log record;
an object-identifier field for storing information indicating a location of update data within the database;
a length field for storing information indicating a size of update data;
a field for storing information indicating a location of the previous log record to be used to recover a subsequent transaction when a transaction is recovered using log records recorded in a log pool on the transaction-by-transaction basis;
a field for storing a old-value data as information used for recovering the transaction; and
a field for storing a new-value data as information used for duplex.

6. The method as set forth in claim 4, wherein the step a) includes the step of:
if the allocated log page does not exist or a log-record storage space included in the allocated log page is insufficient, obtaining a new log page allocated from the log page and storing the log record in the log page.

7. A computer-readable recording medium in a duplex computer, the recording medium recording a program to perform the functions of:
a) creating at least one log record on a transaction-by-transaction basis if a query processor of the active side receives a update command from a user, obtaining at least one log page allocated from a log pool, connecting the log page to a transaction table, storing the log record in the log page, and changing data of a corresponding database portion;
b) transmitting the log record to the standby side if the transaction is committed, returning the allocated log page to the log pool, and terminating the transaction;
c) obtaining at least one log page allocated from a log pool if the standby side receives the log record from the active side, connecting the log page to a transaction table, and storing the received log record in the log page; and
d) transmitting a result of the reception to the active side after the log record is stored in the standby side, and updating a memory database using the stored log record.
